(19) United States
(12) Patent Application Publication
(10) Pub. No.: US 2003/0235193 A1
(43) Pub. Date: Dec. 25, 2003

(54) Communication relaying method, communication relaying apparatus, communication network apparatus, network address determining method, communication method, communication terminal apparatus and network name server apparatus

(76) Inventor: Hajime Hosaka, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/379,773

(22) Filed: Mar. 5, 2003

(30) Foreign Application Priority Data
Mar. 7, 2002 (JP) 2002-062551

(51) Int. Cl. H04L 12/56

(52) U.S. Cl. 370/389

(57) ABSTRACT

A network is to be constructed in which the relaying time is reduced to as short a time as possible. A network switch 1 checks the first one bit of an input header IHD of a packet. If the first one bit of the input header IHD is 0, the packet is relayed to an output port 39. The address 0, used for relaying, is moved to the leading end of the output trailer OTL in an output packet OUTpack.

### BACKGROUND OF THE INVENTION

1. Field of the Invention

This invention relates to a communication relaying method, a communication relaying apparatus, a communication network apparatus, a network address determining method, a communication method, a communication terminal apparatus and a network name server apparatus, for constructing a network by relaying among various transmission routes.

This application claims priority of Japanese Patent Application No. 2002-062551, filed on Mar. 7, 2002, the entirety of which is incorporated by reference herein.

2. Description of Related Art

Nowadays, the communication network is finding drastically increasing application. In particular, the application in the field of real-time games, Internet telephony or teleconferencing, in which real-time and interactive communication may be had simultaneously with plural counterpart parties, using computer graphics or video/audio streaming, is thought to be promising.

However, the relaying delay in the current network, in particular the computer network, cannot be reduced to more than a certain extent because of structural constraint of the network relaying apparatus.

In a conventional network relaying apparatus, the relay processing was carried out using a network switch 1 shown in FIG. 1.

The network switch 1, shown in FIG. 1, includes a header readout unit 110, a relaying destination deciding processing unit 120 and a relaying processing unit 130. First, the header readout unit 110 reads-in part or all of the packet header, and the relaying destination deciding processing unit 120 then retrieves a table, based on an address taken out from the read-in packet header to decide on the relaying destination. Finally, the relaying is carried out by the relaying processing unit 130 based on the relaying destination decided on by the relaying destination deciding processing unit 120.

With this configuration, the packet relay delay time cannot be made shorter than the sum of the time for reading in the entire address from the packet header in the header readout unit 110 and the time for retrieving the relay table based on the address in the relaying destination deciding processing unit 120.

Meanwhile, in an application of real-time interactive communication, what is crucial in presenting a easy-to-use application is to shorten the delay time incurred on the network. For example, the delay time in the telephone speech is desirably as short as possible. In e.g., a parallel computer, when plural computers interconnected over a network switch are run in a time relationship to one another, the communication delay should be as short as possible in order to reduce the latency for waiting for the end of the termination of processing of other computers, thereby to improve the performance of the entire system.

In light of the foregoing, such a method and apparatus for network relaying and a network architecture, in which the relay time is made as short as possible, has been strongly desired.

### SUMMARY OF THE INVENTION

It is therefore an object of the present invention to provide a communication relaying method, a communication relaying apparatus, a communication network apparatus, a network address determining method, a communication method, a communication terminal apparatus and a network name server apparatus, for constructing a network by relaying among various transmission routes, whereby it is possible to construct a network with the relay time which is as short as possible.

According to the present invention, the relaying destination is directly determined based on part of an address initially read-in in the input packet. By this relaying destination determining method, the time since the start of read-in of a header until decision of the relaying destination is minimized. In case plural switches are interconnected to form a network segment, the switches in circuit may be operated with the minimum delay by removing the address portion used in the previous relaying.

Thus, in one aspect, the present invention provides a communication relaying method comprising determining one or more relaying destination from among a plurality of relaying destinations depending on the information of one or more bits in a received packet, deleting the information of one or more bits, used in determining the relaying destination, from the original location of the information in the packet, and transferring the packet, freed of the information of one or more bits, to the relaying destination.

In another aspect, the present invention provides a communication relaying apparatus comprising relaying destination determining means for determining one or more relaying destination from among a plurality of relaying destinations depending on the information of one or more bits in a received packet, information deleting means for deleting the information of one or more bits, used in determining the relaying destination, from the original location of the information in the packet, and packet transmitting means for transmitting the packet, freed of the information of one or more bits, to the relaying destination.

In still another aspect, the present invention provides a communication network apparatus comprising a set of communication relaying apparatus and a set of communication terminal apparatus interconnected by a transmission route; each communication relaying apparatus of the set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of the information in the packet, and packet transmitting means for transmitting the packet, freed of the information of one or more bits, to the relaying destination.

In a further aspect, the present invention provides a method for determining a network address in a communication network apparatus comprising a set of communication relaying apparatus and a set of communication terminal apparatus, interconnected by a transmission route, each communication relaying apparatus of the set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of the information in the packet, and packet transmitting means for transmitting the packet, freed of the information of one or more bits, to the relaying destination. The information of one or more bits representing each relaying destination for each communication relaying apparatus existing on a route from a communication terminal apparatus of a source of transmission to a communication terminal apparatus of a destination of transmission is stated in the route sequence so as to be used as a network address.

In a further aspect, the present invention provides a communication method in a communication network apparatus comprising a set of communication relaying apparatus and a set of communication terminal apparatus, interconnected by a transmission route, each communication relaying apparatus of the set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of the information in the packet, and packet transmitting means for transmitting the packet, freed of the information of one or more bits, to the relaying destination. The method comprises stating in a packet a network address in the sequence of a route from a communication terminal apparatus of a source of transmission to a communication terminal apparatus of a destination of transmission, the information of one or more bits representing each relaying destination for each communication relaying apparatus existing on the route, and transmitting the resulting packet.

In a further aspect, the present invention provides a communication terminal apparatus in a communication network apparatus comprising a set of communication relaying apparatus and a set of communication terminal apparatus, interconnected by a transmission route, each communication relaying apparatus of the set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of the information in the packet, and packet transmitting means for transmitting the packet, freed of the information of one or more bits, to the relaying destination. The communication terminal apparatus comprises network address stating means for stating, in the sequence of a route from a communication terminal apparatus of a source of transmission to a communication terminal apparatus of a destination of transmission, the information of one or more bits representing each relaying destination for each communication relaying apparatus existing on the route, in a packet, and packet transmitting means for transmitting the packet which has the network address entered by the network address stating means.

In yet another aspect, the present invention provides a network name server apparatus connected to a communication network apparatus comprising a set of communication relaying apparatus and a set of communication terminal apparatus, interconnected by a transmission route, each communication relaying apparatus of the set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of the information in the packet, and packet transmitting means for transmitting the packet, freed of the information of one or more bits, to the relaying destination, each communication terminal apparatus of the set of communication terminal apparatus including network address stating means for stating, in the sequence of a route from a communication terminal apparatus of a source of transmission to a communication terminal apparatus of a destination of transmission, the information of one or more bits representing each relaying destination for each communication relaying apparatus existing on the route, in a packet, and packet transmitting means for transmitting the packet which has the network address entered by the network address stating means. The network name server apparatus comprises network address generating means for accepting an inquiry of an address, using, as a key, a name of a communication counterpart terminal apparatus, with which the communication terminal apparatus is to communicate, for generating a network address stating, in the sequence of a route from a communication terminal apparatus of a transmission source to a communication terminal apparatus of a transmission destination, the information of one or more bits representing each relaying destination for each communication relaying apparatus existing on the route; wherein. The network address generated by the network address generating means is returned, responsive to the inquiry, as a network address relaying between the terminal apparatus.

According to the present invention, described above, in which one or more relaying destination is determined from plural relaying destinations, in accordance with the information of one or more bits in a received packet, the information of one or more bits, used in determining the relaying destination, is deleted from the original location of the information in the packet, and the resulting packet, freed of the information of one or more bits, is transmitted to the relaying destination. The relaying destination can be verified at the moment of arrival of the leading one bit of the packet header, thus expediting the relaying. Additionally, the relaying is possible using a switch of a simpler structure.

According to the present invention, in which the information of one or more bits, used for determining the relaying destination in the received packet, is appended in rear of the original location of the information in the packet, and the resulting packet is transmitted to the relaying destination, the relaying route traversed by the arrival packet can be transmitted to the destination of transmission as high speed relaying properties are not lost.

According to the present invention, in which the location in the packet of the information of one or more bits, used in determining the relaying destination, is set in a position of a specified number of bits as counted from the leading end of the packet, or is variably set in a position that can be determined by the information ahead of the relaying destination, the packet can be transmitted with different priority in such a manner that the high speed relaying properties are not lost or lowered only to the least extent possible.

According to the present invention, in which the buffer used is varied, using the priority information entered ahead of the relaying destination, depending on the relaying priority or on the busy state, the packet can be transmitted with different priority in such a manner that the high speed relaying properties are not lost or lowered only to the least extent possible.

According to the present invention, in which the priority information of the packet with high priority is represented with a code of a smaller number of bits, while the priority information of the packet with low priority is represented with a code of a larger number of bits, the packet can be transmitted with different priority in such a manner that the high speed relaying properties are not lost or lowered only to the least extent possible.

According to the present invention, it is determined, based on the priority information, whether a packet is to be immediately destructed during the busy time, or on buffer overflow, or whether a packet is buffered in the same buffer as the low priority packet and relayed, depending on the priority information, stated ahead of the priority information, so that the packet can be transmitted with different priority in such a manner that the high speed relaying properties are not lost or lowered only to the least extent possible.

Moreover, according to the present invention, the relaying destination can be verified in the shortest time possible every time the respective relaying apparatus are traversed, even in a complicated network including a large number of relaying apparatus, interconnected over a transmission route, so that such a computer network may be constructed in which the overall relay delay time is minimized.

In addition, according to the present invention, each terminal may inquire of an appropriate name server to obtain a network address containing the entire relay route to the destination of communication, so that it is unnecessary for each terminal to hold the network addresses of the communication destinations in their entirety. The relaying route may be reversed in the bit sequence for return to a counterpart party. On the other hand, the number of times of relaying can be used as a basis to control the network security, based on the empirical rule that an aggressor uses a network with a larger number of times of relaying.

Thus, with the present invention, it is possible to implement a communication relaying apparatus with shorter delay time and, with use of this apparatus, to implement a network architecture with a shorter delay time.

### BRIEF DESCRIPTION OF THE DRAWINGS

FIG. 1 is a-block diagram showing the structure of a network switch used in a network relaying apparatus of the related art.

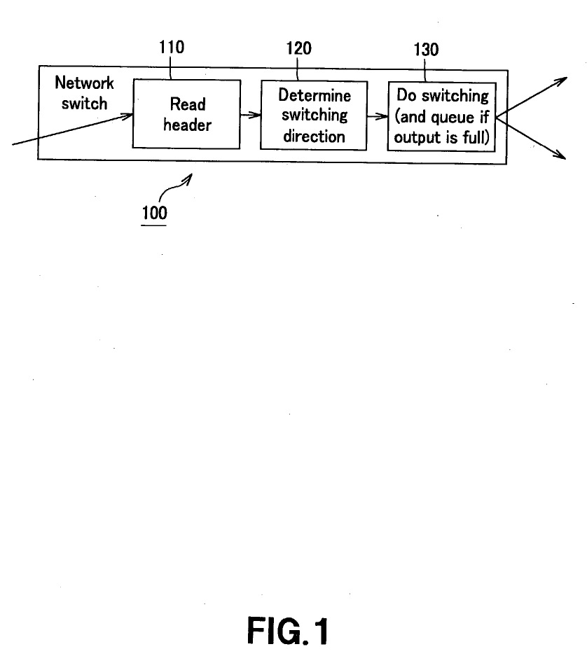

FIG. 2 shows the function of a one-input two-output network switch used in a first embodiment of the present invention.

FIG. 3 schematically shows a relaying operation in which the leading bit in the network switch is 0

FIG. 4 schematically shows a relaying operation in which the leading bit in the network switch is 1.

FIG. 5 is a block diagram showing a specified structure of the network switch.

FIG. 6 is a block diagram showing an illustrative structure of a butterfly switch constructed using the network switch.

FIG. 7 is a block diagram showing an illustrative structure of a switch fabric constructed using the network switch.

FIG. 8 is a block diagram showing an illustrative structure of a network segment constructed using the switch fabric

FIG. 9 schematically shows the connection between the client and the server relayed through the network segment.

FIG. 10 schematically shows the connection between a server and the client relayed through the network segment.

FIG. 11 schematically shows an instance of a relaying operation of a packet having a port number appended thereto.

FIG. 12 schematically shows the concept of a name server.

FIG. 13 schematically shows an instance of an operation for function limitation which is based on the number of times of relaying.

FIGS. 14A and 14B schematically show the buffering operation during the busy time of a network switch with two-level priority employed in the second embodiment of the present invention.

FIGS. 15A and 15B schematically show the readout sequence from a buffer after end of the busy state in the network switch with two-level priority.

FIGS. 16A and 16B schematically show the relaying operation during ready time in the network switch with two-level priority.

FIG. 17 is a block diagram showing an illustrative structure of the network switch with two-level priority.

FIG. 18 is a block diagram showing an illustrative structure of a butterfly switch constructed using the network switch with two-level priority.

FIG. 19 schematically shows a third embodiment of the present invention in which the number of classes of the packet priority is increased to four.

### DESCRIPTION OF THE PREFERRED EMBODIMENTS

Referring to the drawings, preferred embodiments of the present invention will be explained in detail.

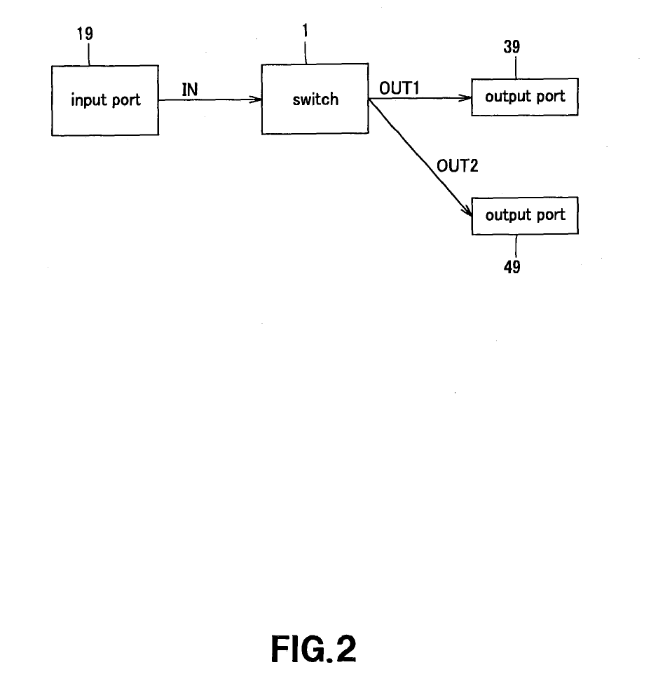

In a first embodiment of the present invention, hereinafter explained, a network switch 1, shown in FIG. 2, having one input port 19 and two output ports 39, 49 and in which a packet input at an input port 19 is output to one of the output ports 39, 49 depending on an address. This network switch 1 is a one-input two-output switch for branching one serial data input IN to two serial data inputs OUT1, OUT2.

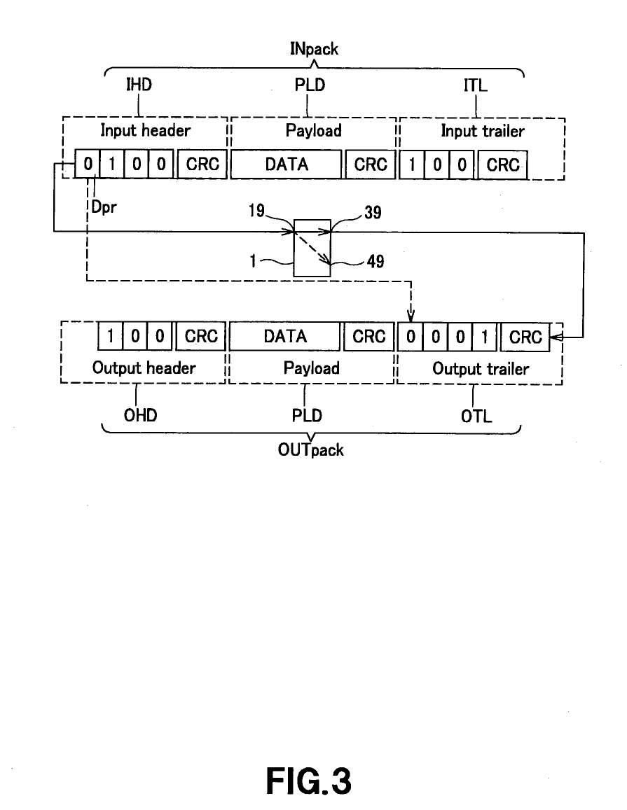

If the first bit input to the input port 19 is 0, the network switch 1 performs the relaying operation shown in FIG. 3.

An input packet INpack of the network switch 1 is made up by an input header IHD, a payload PLD, which is the content of the communication, and an input trailer ITL. An output pack OUTpack is made up by an output header OHD, a payload PLD and an output trailer OTL.

In the headers IHD and OHD, there are contained relaying addresses used by the switch and which are passed through later on and the CRC for error check. In the payload PLD, there are contained at least data to be transmitted and the CRC, whereas, in the trailers ITL and OTL, there are contained bit sequence inverted versions of the relaying addresses used by the switched and which have already been passed through and the CRC.

The network switch 1 checks the first one bit of the input header IHD. In the embodiment shown in FIG. 3, the first one bit of the input header IHD is 0, so that the packet is relayed to the output port 39. The address 0, used for relaying, is shifted to the leading end of the output trailer OTL in the output packet OUTpacket.

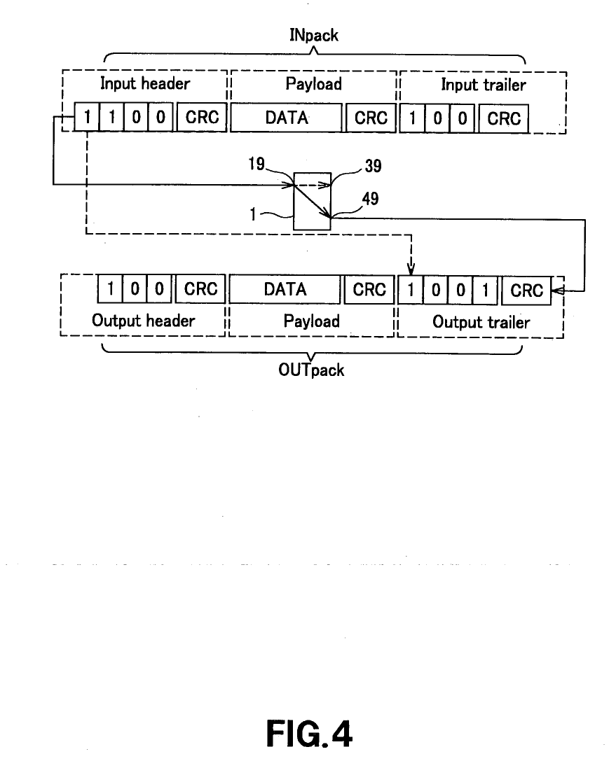

The relaying operation of the network switch 1 in case the leading bit is 1 is shown in FIG. 4. In this embodiment, shown in FIG. 4, the network switch 1 checks the leading bit of the input header IHD of the input pack INpack. Since this is 1, the network switch 1 relays the packet to the output port 49, while moving the address 1, used for relaying, to the leading end of the output trailer OTL in the output packet OUTpack.

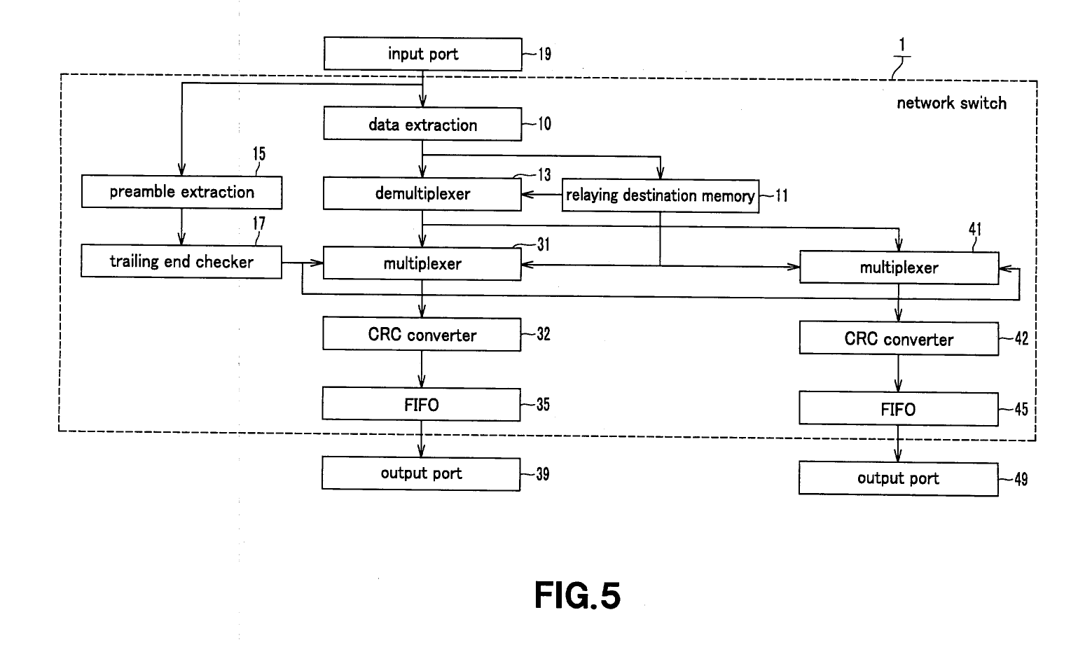

FIG. 5 shows a specified illustrative structure of the network switch 1 adapted for carrying out the relaying operation.

The network switch 1, shown in FIG. 5, includes a data extraction unit 10, a relay destination memory 11, a demultiplexer 13, a preamble extraction unit 15, a trailing end checker 17, multiplexers 31, 41, CRC converters 32, 42, and FIFO memories 35, 45.

In this network switch 1, input data, input to the input port 19, is branched and supplied to the data extraction unit 10 and to the preamble extraction unit 15.

The preamble extraction unit 15 detects data usually appended to the leading end of a serial data packet, or non-existing portions, to initialize a CRC checker.

In serial data transfer, data and clocks are usually coded and transmitted in this state. Thus, the data extraction unit 10 separates clocks from the input and sends only data to the demultiplexer 13, while sending one bit of leading data of the packet as relay destination data Dpr to the relay destination memory 11. This relay destination memory 11 memorizes this one bit.

Then, based on the relay destination data Dpr, sent from the relay destination memory 11, the demultiplexer 13 sends the data less the relay destination data Dpr to one of plural multiplexers 31 and 41. It is now supposed that the relay destination data Dpr is 0 and that the data less the relay destination data Dpr is sent to the multiplexer 31.

Based on the count of the number of bits passed, and/or on the CRC check, the trailing end checker 17 detects the trailing ends of the header, data and the trailer.

When the trailing end of the CRC of DATA has been detected by the trailing end checker 17, the multiplexer 31 appends the relay destination data Dpr, obtained from the relay destination memory 11, to the leading end of the next following trailer to send the resulting data to the CRC converter 32.

The CRC converter 32 calculates the bit positions of the CRC, changed by removing the relay destination address from the header, and the bit positions of the CRC changed by appending the relay destination address to the trailer. By the bit positions herein are meant those of an optional number of bits not less than 0 bit. The original CRC in the resulting bit positions is changed to obtain the correct CRC after relaying.

The packet, now having the correct CRC, is output through the FIFO memory 35 to the output port 39. If the connection destination of the output port is not busy, the packet is output immediately. However, if the connection destination is busy, the packet is buffered in a first-in first-out sequence in the FIFO memory 35.

In similar manner, if the content of the relay destination memory 11, that is the relay destination data Dpr, is 1, the DATA freed of the relay destination data Dpr is sent from the demultiplexer 13 to the multiplexer 41, and thence transmitted through the CRC converter 42 and the FIFO memory 45 to undergo similar processing so as to be output at the output port 49.

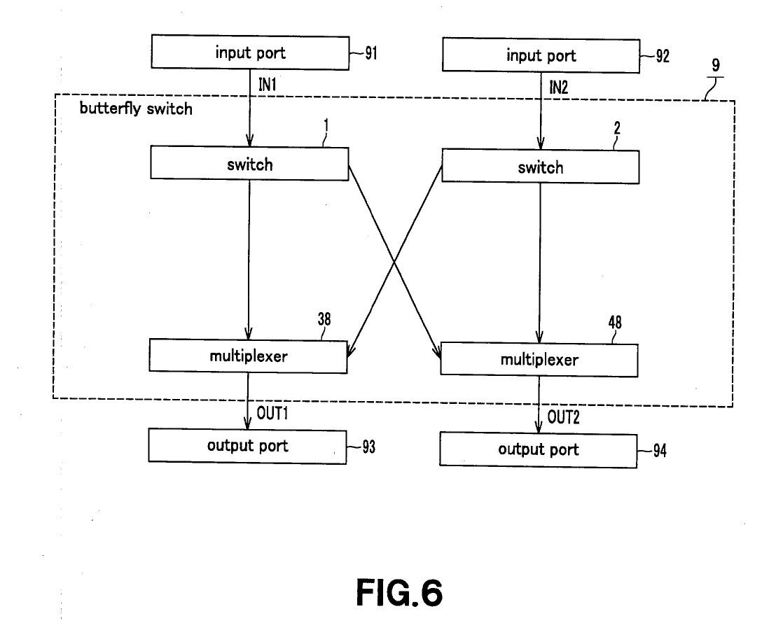

An embodiment in which a 2-input 3-output butterfly switch 9 is constructed using a switch 2 of the same structure as that of the network switch 1, is shown in FIG. 6.

In this butterfly switch 9, an input IN1 of an input switch 91 is switched by the network switch 1 and is sent to multiplexers 38 or 48 depending on the switching destination. Similarly, an input IN2 of an input switch 92 is switched by the network switch 2 and is sent to the multiplexers 38 or 48.

The multiplexer 38 outputs the input IN1 or IN2, received from the two network switches 1 or 2, respectively, whichever has arrived at the multiplexer 38 earlier, to an output port 93. If both inputs have arrived simultaneously from the inputs IN1 and IN2, an output OUT1 or OUT2 of the network switches 1 or 2 is kept waiting in busy state. Since a FIFO memory is enclosed as a buffer memory in the each of the network switches 1 and 2, the DATA is not lost except in case of overflow. The multiplexer 48 also has a similar function.

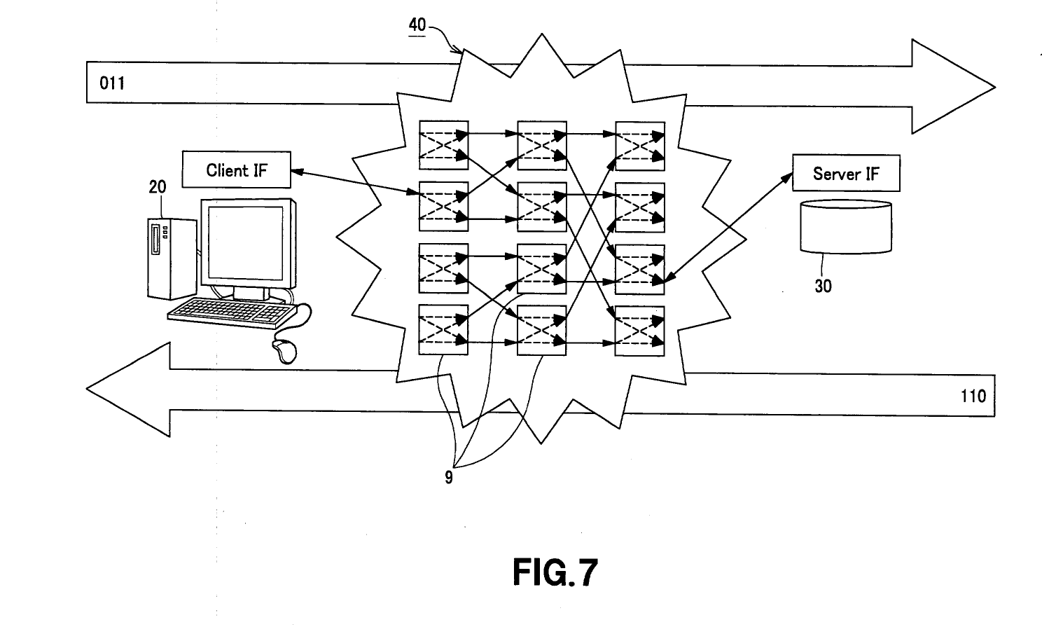

FIG. 7 shows an embodiment in which a large number of butterfly switches 9 are interconnected to form a switch fabric 40 interconnecting a client 20 and a server 30. The switch fabric 40 may be of any optional configuration, such as a banyan, crossbar or modifications thereof.

In constructing the switch fabric 40, input/output port pairs are determined so that an address from a certain first port to another second port represents bit inversion of that of an address from the second port to the first port.

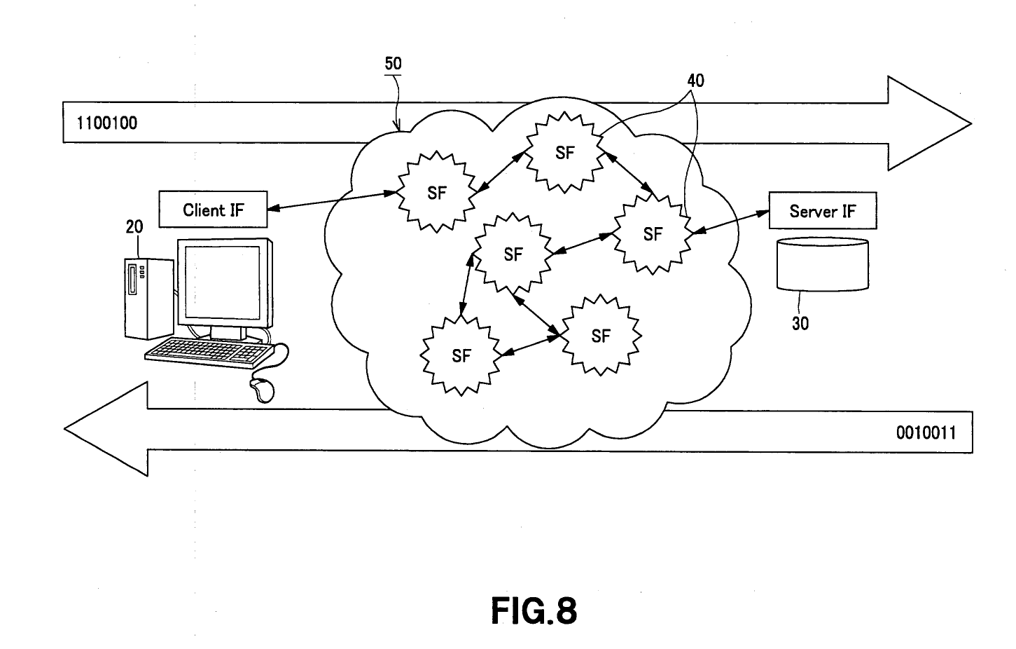

FIG. 8 shows an instance of constructing a network segment 50 interconnecting the client 20 and the server 30 by connecting the switch fabrics 40 via a communication route. In the network segment 50, connection is again made so that an address from a certain first port to another second port represents a reverse bit sequence of that of an address from the second port to the first port.

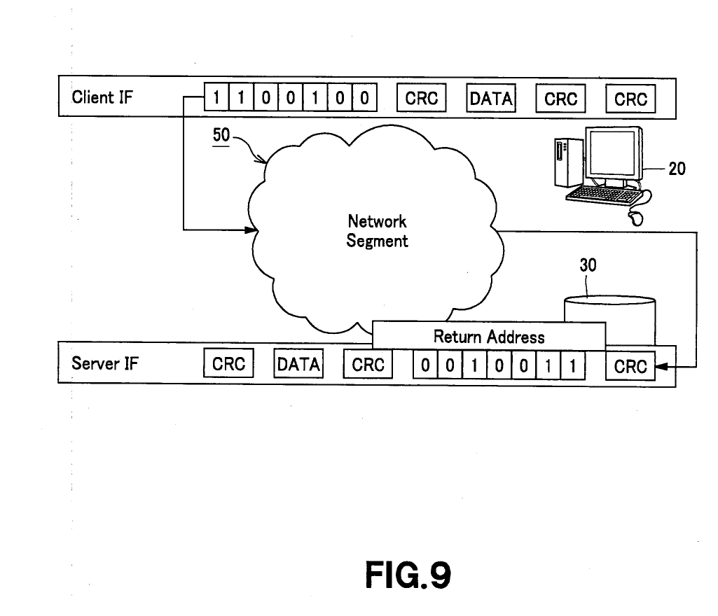

FIG. 9 shows a connection between the client 20 and the server 30 through the network segment 50. The packet sent from the client to the network segment 50 has an address to the server 30 of [1100100] in a header, with the trailer being void.

This packet is routed through a large number of network switches contained in the network segment 50, whereby the header address is sequentially deleted and moved to the trailer. As a result, the header of the packet received by the server 30 becomes void, with the entire address having been moved to the trailer. In the trailer is taken a return address [0010011], which represents the reverse bit sequence to that of the transmission address [1100100] from the client 20 to the server 30.

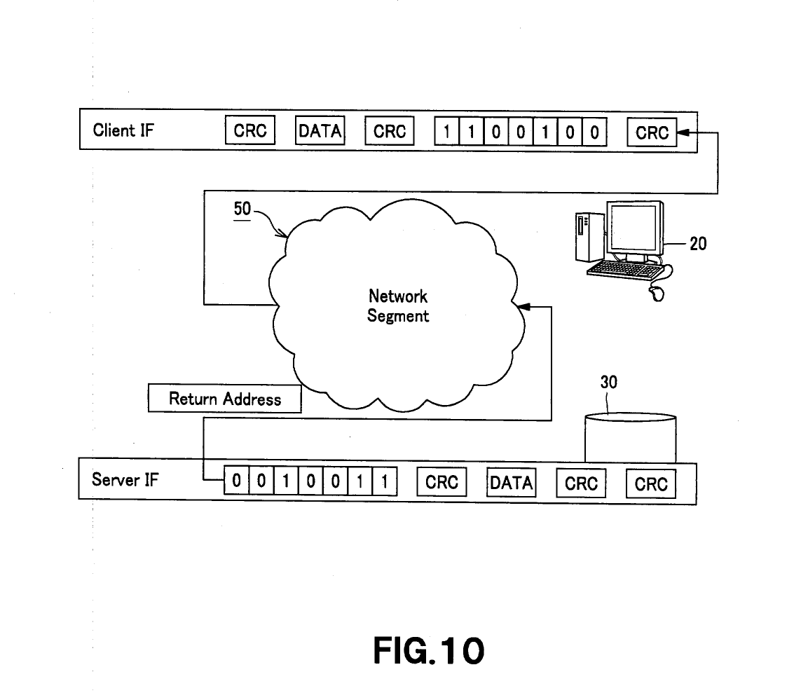

The server 30 performs processing based on the DATA to return the results to the client 20. The connection is shown in FIG. 10.

The server 30 is able to use the trailer of the packet, received from the client 20, directly as a return address [0010011]. It is because the rule that the reverse bit sequence of the transmission address [1100100] becomes the return address [0010011] is observed in the communication within the network segment 50.

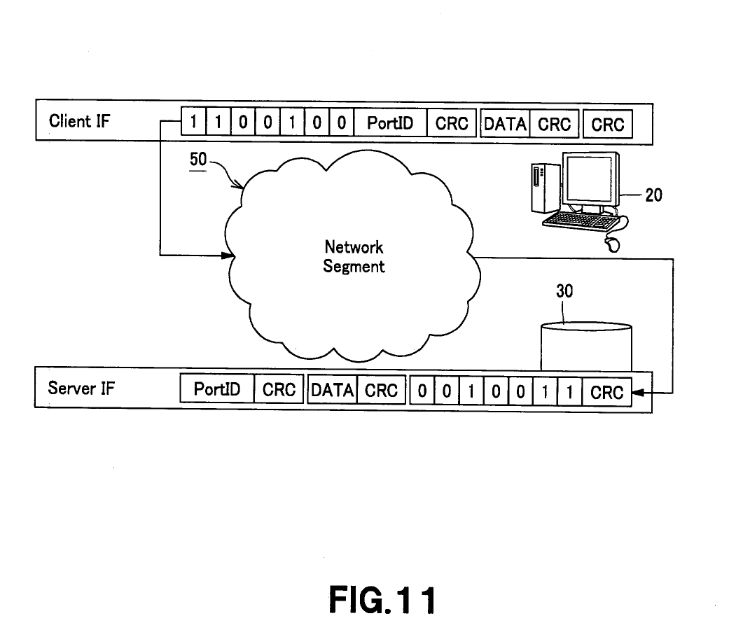

A port number (port ID) may be stated following the address in the packet header. A typical relaying operation for a packet with the port number appended thereto is shown in FIG. 11. The port number is a bit sequence representing a gross sort or protocol of the services rendered in the network communication.

For example, port numbers of variable lengths are allocated to different protocols, as follows:

port number [00]=PING

port number [010]=HTTP

port number [0110]=DNS

port number [0111]=SMTP

port number [110]=SNTP

port number [1110]=POP.

When the packet which has traversed the totality of the switches of the network segment 50 has reached the server 30, the header address is moved in its entirety to the trailer, while the port number is left in the header. The header interprets the contents of the DATA, based on the value of the port number, and performs appropriate processing to return the result to the client 20.

In the present embodiment, the case of the port number being of a variable length is shown under the assumption that a short code is allocated to the protocol of a higher use frequency. However, the operation is the same when a port number of a fixed length, such as 16 bits, such as is used in a majority of Internet protocols, is used.

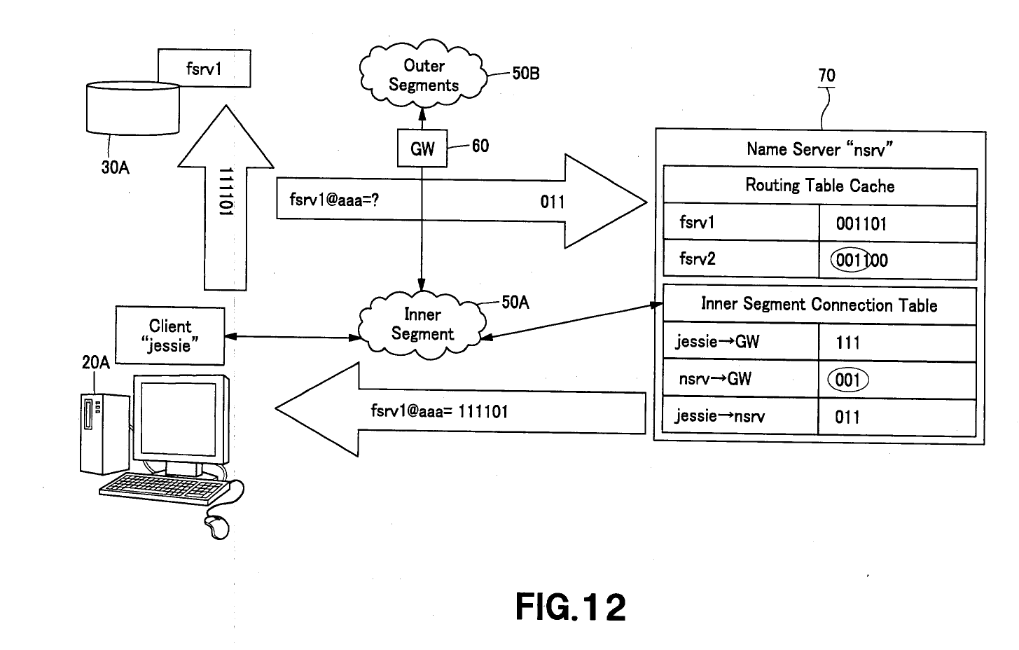

A name server may also be connected to the network segment 50 as necessary to change the name of the communication equipment to the network address or vice versa. FIG. 12 shows the concept of the name server.

In a network server, connected to the network segment, the totality of connections in the same network segment are stored as a database. Although the method for forming the database is not explained here, the totality of the connections may be stored as a database by a manual operation, or a range of addresses with consecutive address values may be sequentially automatically generated and inquiries may then be made to a counterpart party.

The totality of the network equipment, connected to the network segment, are termed nodes.

It is assumed that a client “Jessie” 20A inquires of a name server “nsrv” 70A about an address of a gateway “GW” 60 on a segment 50A which is the same as that of the client itself. It is presupposed that the client 20 has an address of the name server “nsrv” 70 again by a method such as manual setting.

In this case, a packet is sent from the client “Jessie” 20A to the name server “nsrv” 70 as the port number corresponding to the protocol of the name server “nsrv” 70 and the address of the name server “nsrv” 70 are specified. In the DATA, the name of the counterpart party of communication has been stored under a format prescribed by the protocol of the name server “nsrv” 70.

The name server “nsrv” 70 specifies the client “Jessie” 20A, as a transmitter, based on the reverse order return address appended to the packet trailer. The totality of node names, owned by the name server “nsrv” 70, and the node-to-node connection database, are then retrieved to return an address for communication from the client “Jessie” 20A to the gateway “GW” 60.

In the network, shown here, two network segments 50A, 50B are interconnected by the gateway “60”. It is assumed that the name server “nsrv” 70 has stored therein the connections of the network segment, connected to itself, as a database, while having stored therein the addresses in the other segment of the communication destination, having a higher use frequency, as a database.

It is also assumed that the name server “nsrv” 70 also supervises the connection points to the neighboring network segment, and that the name server is aware that the inner segment 50A and the outer segment 50B are interconnected through the gateway “60”.

The case in which the client “Jessie” 20A inquires of the name server “nsrv” 70 about a network address for communication with a file server “fsrv1” 30A.

An inquiry packet is first sent to the name server “nsrv” 70, using the name server protocol. In the inquiry packet, the name of the destination of communication being inquired must be stated in the DATA portion thereof.

The name server “nsrv” 70, which has received the inquiry packet, then is able to realize that the party which made the inquiry is the client “Jessie” 20A, because the bit inversion of the address from the client “Jessie” 20A to the name server “nsrv” 70 has been stated in the trailer of the received packet, with the packet having the entire address in the segment to which the name server is connected.

The name server “nsrv” 70 retrieves a cache table, based on the name of the destination of communication. Here, an address from the name server “nsrv” 70 to the file server “fsrv1” 30A is acquired.

The address that is in the cache table is compared to an address from the name server “nsrv” 70 to the gateway “GW”, in order to search the address in the cache table having the leading portion coincident with the address to the gateway “GW”. If there are coincident addresses, it is determined that these addresses are connected to each other through the common gateway “GW” 60.

The portion of the address to the file server “fsrv1” 30A which is common to the address from the name server “nsrv” 70 to the gateway “GW” is then removed and replaced by the address from the client “Jessie” 20A to the gateway “GW” 60. By so doing, the address for the client “Jessie” 20A to communicate with the file server “fsrv1” 30 through the gateway “GW” is generated.

The name server “nsrv” 70 returns the address, generated as the results of retrieval by the name server, to the client “Jessie” 20A. The client “Jessie” 20A uses this address to have communication with the file server “fsrv1” 30A.

The above is the case in which the address of the counterpart party has been found in the cache table. If there is no such address, the name server “nsrv” 70 sequentially issues inquiries to the name server of the other network segment, connected thereto via gateway “GW” 60, to retrieve the address associated with the name of the counterpart party of communication. If retrieval has been made with success, the address generated based on the retrieved results is returned.

The functional limitations by the number of times of relaying are hereinafter explained.

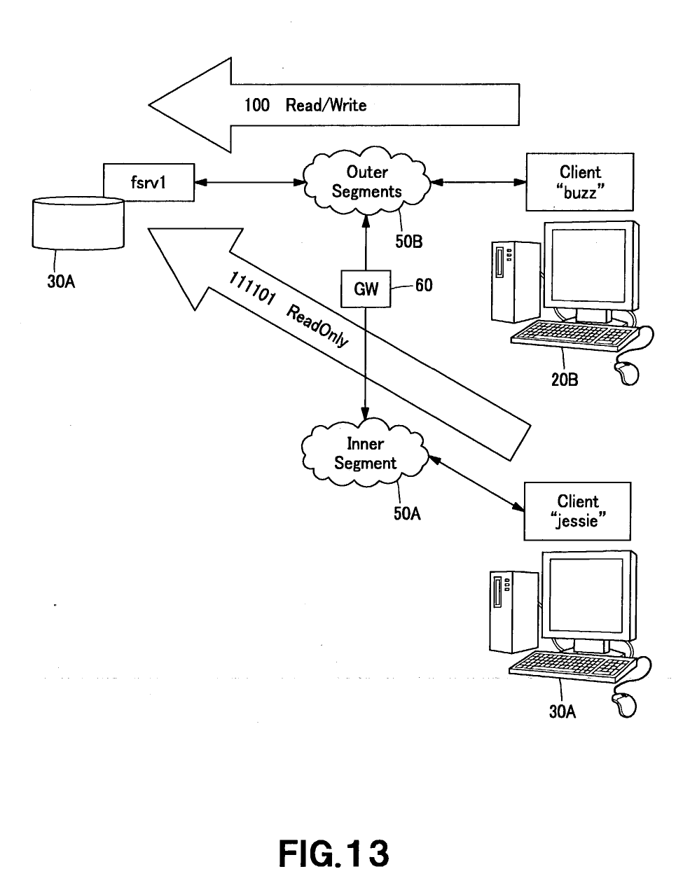

FIG. 13 shows a network composed of two network segments 50A, 50B. To the network segment 50B is connected the file server “fsrv1” 30A. This file server “fsrv1” 30A is placed under limitations that only file readout is possible from the client having 6 hops or less, such as a 6-hop client “Jessie” 20A, while both file readout and file writing are possible from the client having 3 hops or less, such as a 3-hop client “buzz” 20B.

In this manner, limitations are imposed as to the server 30 depending on the number of times of relaying. Empirically, the larger the number of hops of a network, the less elaborate becomes the management, such that the possibility of attack by an aggressor is increased, such that it becomes possible to offer services of higher functionality to the client 20B with the smaller number of hops, and to decrease the services rendered to the client with the larger number of hops.

In the present embodiment, described above, part of the address, removed from the header, is appended to the trailer and used as a return address. If the address appended to the trailer is not used by the destination, the operation on the relaying is not changed even if this function is removed.

Meanwhile, it is not necessarily the case that a sufficient communication capacity is available at all times on the network, such that part or all of the network is frequently in a congested state. If, under these situations, if the usage with high real-time requirements, such as video or speech, and the usage with low real-time requirements, such as E-mail or Web browsing, are to co-exist, there arises a situation that priority shall be appended to the packet such that the relay algorithm need to be changed depending on the priority.

A second embodiment of the present invention in which a packet having appended thereto a bit representing the priority 0 or a bit representing the priority 1 is relayed ahead of the address of the packet header is now explained.

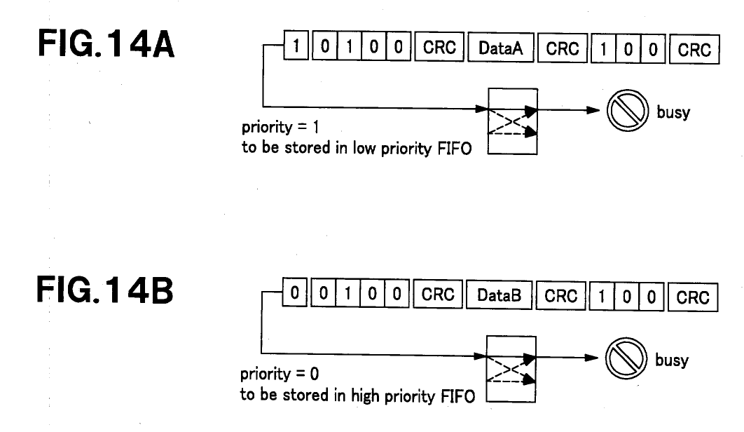

FIGS. 14A and 14B show the concept of buffering for an assumed case in which a certain output port is busy and cannot issue an output.

It is now assumed that, as shown in FIG. 14A, a packet containing Data A has arrived first. Since the priority packet at the leading end of the packet is 1, the packet is buffered in a low priority FIFO memory.

It is then assumed that, as shown in FIG. 14B, a packet containing Data B has arrived. Since the priority packet at the leading end of the packet is 0, the packet is buffered in a high priority FIFO memory.

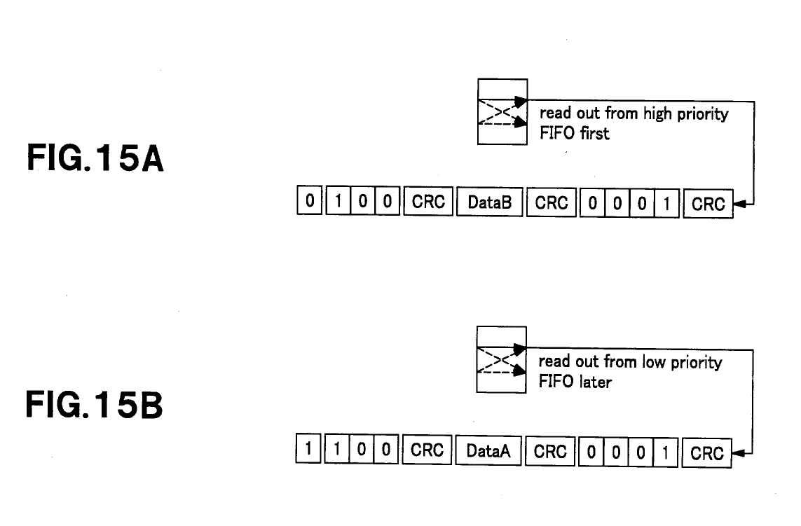

The readout sequence from the buffer after the busy state is annulled in this state is shown in FIGS. 15A and 15B.

It is the data with the priority bit 0, stored in the high priority FIFO memory, that is read out first when the busy state is annulled, as shown in FIG. 15A. After the entire data of the high priority FIFO memory has been sent out, the data of the low priority FIFO memory are read out, as shown in FIG. 15B. As a result, the high priority packet supersedes the low priority packet in the output busy state.

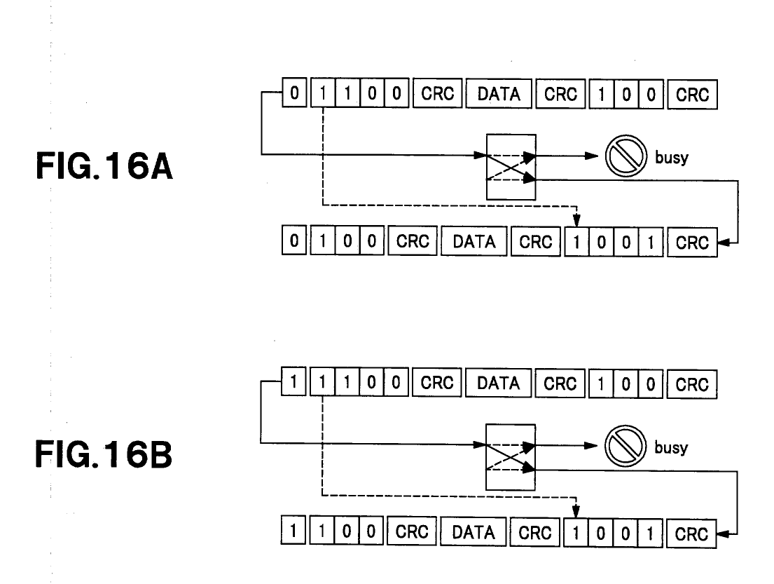

If conversely the output port of the relay destination is not busy, the packet is directly relayed, as shown in FIGS. 16A and 16B. This is the same as in the first embodiment described above.

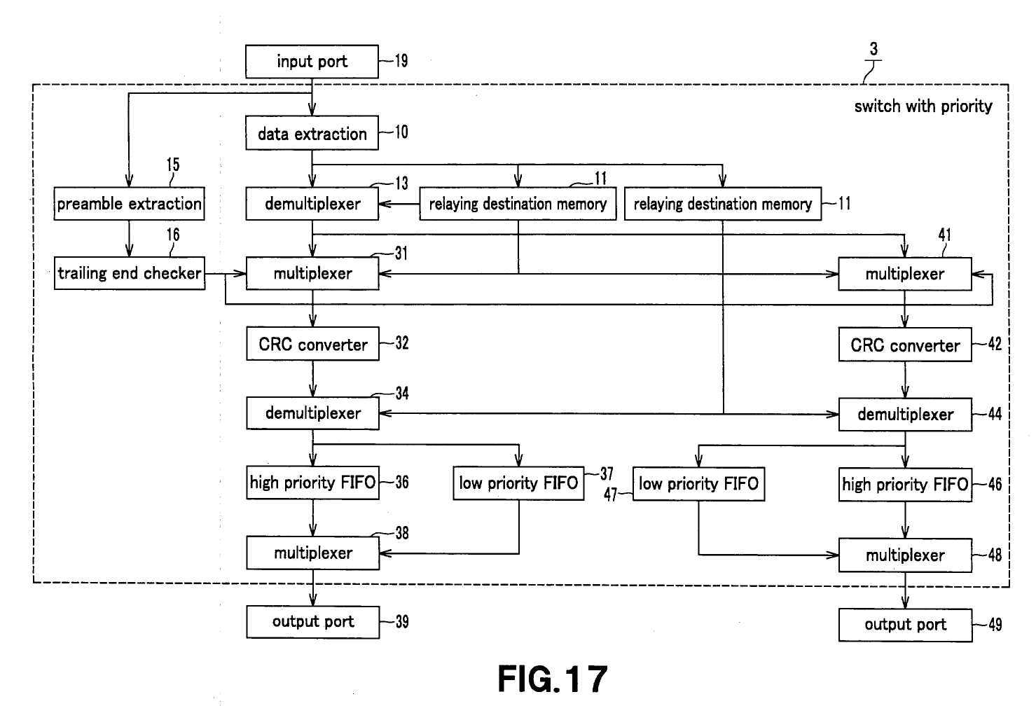

A specified illustrative structure of a network switch 3, executing this relaying operation, is shown in FIG. 17.

The network switch 3, shown in FIG. 17, is an improvement over the network switch 1, shown in FIG. 5. The component parts which are the same as those shown in FIG. 5 are depicted by the same reference numerals and are not explained specifically.

The network switch 3 is made up by a data extraction unit 10, a relay destination memory 11, a priority memory 12, demultiplexers 13, 34, 44, a preamble extraction unit 15, a trailing end checker 17, multiplexers 31, 41, CRC converters 32, 42, high priority FIFO memories 36, 46, and low priority FIFO memories 37, 47.

In this network switch 3, the demultiplexer 13 holds the leading one bit of a packet, which appears directly after the preamble, as priority data PRI in the priority memory 12. The demultiplexer 13 sends the one bit, as the leading end data, of the packet appearing directly in rear of the priority data PRI, as the relay destination data Dpr, to the relay destination memory 11. The relay destination memory 11 holds this one bit.

If the content of the relay destination memory 11 is 0, the DATA freed of the relay destination data Dpr is sent from the demultiplexer 13 through the multiplexer 31 and the CRC converter 32 to the demultiplexer 34.

An output of the demultiplexer 34 is branched depending on the priority information obtained from the priority memory 12, so as to be input to and buffered in the high priority buffer memory 36 or in the low priority buffer memory 37. If the priority is 0, the output of the demultiplexer 34 is input to the high priority buffer memory 36, whereas, if the priority is 0, the output is input to the low priority buffer memory 37. If the high priority FIFO memory 36 is full, the output is input to the low priority buffer memory 37.

If the multiplexer 38 is able to output data, the multiplexer reads out data from the high priority buffer memory 36 or the low priority buffer memory 37. As for the readout sequence, the high priority buffer memory 36 is read out first and, when the high priority buffer memory 36 is void, the low priority buffer memory 37 is read out.

Since there is limitation to the capacity of the high priority buffer memory 36 or the low priority buffer memory 37, it is necessary to take into account the behavior when the busy state of the output port lasts long such that the capacity overflowing state has occurred.

For example, if the high priority buffer memory 36 is full, the demultiplexer 34 is able to destruct the packet. This sort of mounting is effective when the high priority packet is allocated to usage such as telephone or video stream, because picture or speech packets are required to be highly real-time such that late arrival has no meaning.

In similar manner, if the contents of the relay destination memory 11, that is the relay destination data Dpr, is 1, the DATA, freed of the relay destination data Dpr, is sent from the demultiplexer 13 through the multiplexer 41 and the CRC converter 42 to the demultiplexer 44 and buffered in the high priority buffer memory 36 or in the low priority buffer memory 37, depending on the priority information obtained from the priority memory 12, so as to be output via multiplexer 48.

The network switch 3, performing the relaying which takes account of the priority, can optionally be replaced by a network switch in the pre-mentioned embodiment. By this replacement, priority may be taken into account in these other pre-mentioned embodiment.

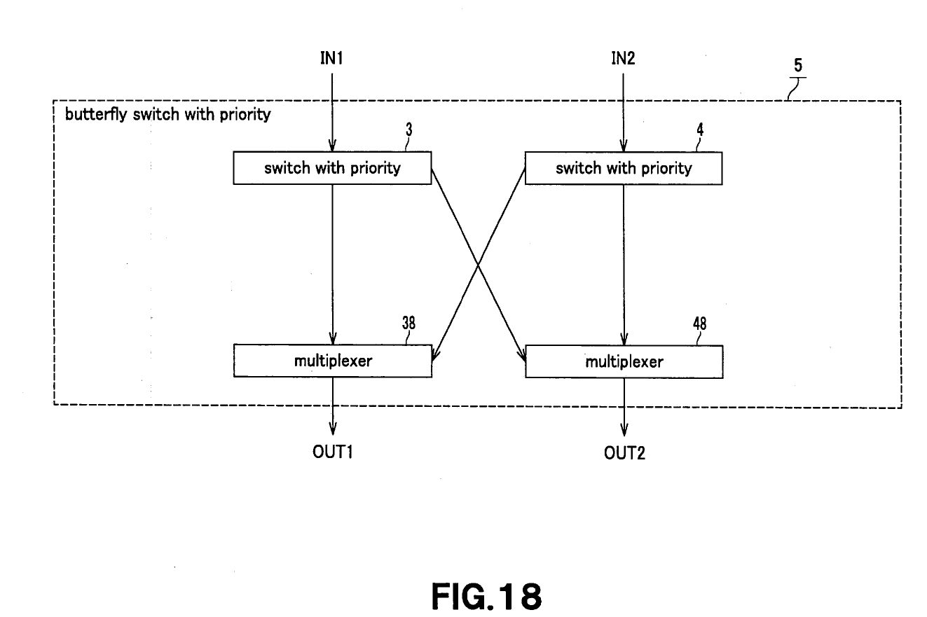

For example, a 2-input 2-output butterfly switch with priority 5 may be constructed using the switch 4 having the same structure as the network switch 3 as shown in FIG. 18.

This butterfly switch 5 is of the same structure as the butterfly switch 9 without the priority as explained with reference to FIG. 6, and has the function similar to that of the butterfly switch 9 except that outrunning of the packet with high priority occurs within the switch with priority during output busy time.

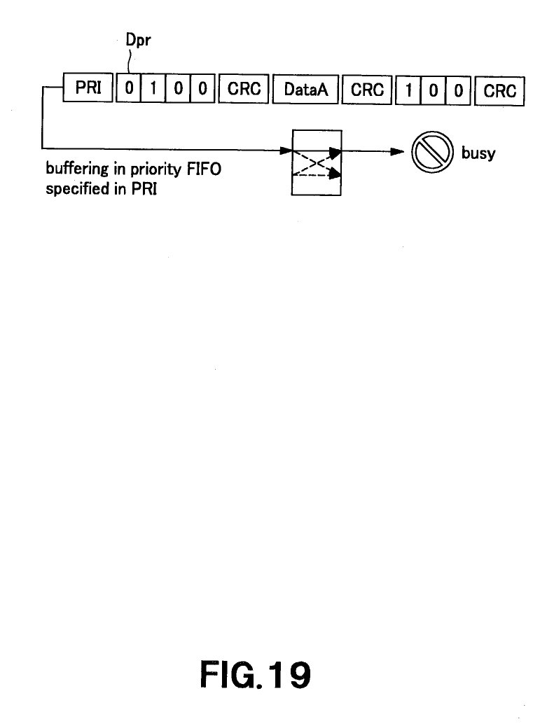

Referring to FIG. 19, a third embodiment of the present invention, in which the number of classes of the packet priority is increased to 4 and yet a long code is allocated to a packet with low priority, is now explained.

In the present third embodiment, the priority is classified into the following sorts:

PRI[0]=Priority 0

When the output port of the relay destination is busy, the packet is buffered in the high priority buffer memory 36. If the overflow of the high priority buffer memory 36 has occurred, the packet is buffered in the low priority buffer memory 37.

PRI[10]=Priority 1

In a busy state, the packet is buffered in the high priority buffer memory 36. If the overflow of the high priority buffer memory 36 has occurred, the packet is destructed.

PRI[110]=Priority 2

In a busy state, the packet is buffered in the low priority buffer memory 37. If the overflow of the low priority buffer memory 37 has occurred, the packet is destructed.

PRI[1110]=Priority 3

In a busy state, the packet is unconditionally destructed, without buffering.

In the present third embodiment, the FIFO memories with four sorts of packet priority and two sorts of priority are used. The present invention is, however, not limited to this embodiment, such that the number of classes of priority may be increased to five or more, or the number of FIFO memories differing in priority may be increased to three or more. In these cases, the operation of buffering to a buffer of lower priority depending on the priority information or destructing a packet in case of overflow of the FIFO memory is the same as that described above.

In the third embodiment, the priority code is of a variable length. Alternatively, the priority code may be varied as the sort of the priority is fixed and the length of the priority bit is constant.

While the invention has been described in accordance with certain preferred embodiments thereof illustrated in the accompanying drawings and described in the above description in detail, it should be understood by those ordinarily skilled in the art that the invention is not limited to the embodiments, but various modifications, alternative constructions or equivalents can be implemented without departing from the scope and the spirit of the invention as set forth and defined in the appended claims.

What is claimed is:

1. A communication relaying method comprising:
determining one or more relaying destination from among a plurality of relaying destinations depending on the information of one or more bits in a received packet;
deleting the information of one or more bits, used in determining the relaying destination, from the original location of said information in said packet; and
transferring the packet, freed of the information of one or more bits, to said relaying destination.

2. The communication relaying method according to claim 1 wherein the information of one or more bits, used for determining the relaying destination in the received packet and deleted, is appended to a location in rear of the original location of said information in said packet, and the resulting packet is transferred to said relaying destination.

3. The communication relaying method according to claim 1 wherein the location in the received packet of said information of one or more bits to be used for determining said relaying destination is fixed at a location of a specified number of bits as counted from the leading end of said received packet.

4. The communication relaying method according to claim 1 wherein the location in the received packet of said information of one or more bits to be used for determining said relaying destination is variably set in a location that can be determined by the information ahead of the relaying destination.

5. The communication relaying method according to claim 1 wherein a buffer used is made to differ, using the priority information stated ahead of the relaying destination, depending on the relaying priority or on the busy state.

6. The communication relaying method according to claim 5 wherein the priority information of the packet with high priority is represented by a code of a smaller number of bits and wherein the priority information of the packet with low priority is represented by a code of a larger number of bits.

7. The communication relaying method according to claim 5 wherein it is determined, based on the priority information, whether a packet is to be immediately destructed during the busy time or destructed when buffer overflow has occurred, or whether a packet is buffered in the same buffer as that for the low priority packet and relayed.

8. The communication relaying method according to claim 1 wherein the communication relayed by a number of times exceeding the maximum allowable number of times of relaying, determined to a value different from one sort of communication to another, is no longer relayed.

9. A communication relaying apparatus comprising:
relaying destination determining means for determining one or more relaying destination from among a plurality of relaying destinations depending on the information of one or more bits in a received packet;
information deleting means for deleting the information of one or more bits, used in determining the relaying destination, from the original location of said information in said packet; and
packet transmitting means for transmitting the packet, freed of the information of one or more bits, to said relaying destination.

10. The communication relaying apparatus according to claim 9 comprising:
information appending means for appending the information of one or more bits, deleted by said information deleting means, in a location in said packet in rear of the original location thereof in said packet; wherein
the information of one or more bits, used in determining the relaying destination in the received packet, and deleted, is appended in a location in said packet in rear of the original location thereof in said packet and transferred to said relaying destination.

11. The communication relaying apparatus according to claim 9 wherein the location in the received packet of said information of one or more bits used for determining said relaying destination is fixed at a location of a specified number of bits as counted from the leading end of said received packet.

12. The communication relaying apparatus according to claim 9 wherein the location in the received packet of said information of one or more bits used for determining said relaying destination is variably set in a location that can be determined by the information ahead of the relaying destination.

13. The communication relaying apparatus according to claim 9 wherein said packet transmitting means includes a plurality of buffer memories for transiently storing a packet transmitted to a relaying destination and wherein the buffer used is made to differ, depending on the relaying priority or on the busy state, using the priority information stated ahead of the relaying destination.

14. The communication relaying apparatus according to claim 13 wherein the priority information of the packet with high priority is represented by a code of a smaller number of bits and wherein the priority information of the packet with low priority is represented by a code of a larger number of bits.

15. The communication relaying apparatus according to claim 13 wherein said packet transmitting means determines, based on the priority information, whether a packet is to be immediately destructed during the busy time or destructed when buffer overflow has occurred, or whether a packet is buffered in the same buffer as that for the low priority packet and relayed.

16. The communication relaying apparatus according to claim 9 further comprising:
relaying limiting means for limiting the relaying based on the number of times of relaying; wherein
the communication relayed by a number of times exceeding the maximum allowable number of times of relaying, determined to a value different from one sort of communication to another, is no longer relayed.

17. A communication network apparatus comprising:
a set of communication relaying apparatus and a set of communication terminal apparatus, interconnected by a transmission route; each communication relaying apparatus of said set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of said information in said packet, and packet transmitting means for transmitting the packet, freed of the information of one or more bits, to said relaying destination.

18. The communication network apparatus according to claim 17 wherein each communication relaying apparatus of said set of communication relaying apparatus includes
network address stating means for stating in a packet a network address stating, in the sequence of a route from a communication terminal apparatus of a source of transmission to a communication terminal apparatus of a destination of transmission, the information of one or more bits representing each relaying destination for each communication relaying apparatus existing on said route, and
packet transmission means for transmitting a packet stating said network address by said network address stating means.

19. The communication network apparatus according to claim 17 wherein said communication relaying apparatus includes relaying limiting means for limiting the relaying based on the number of times of relaying, such that the communication relayed by a number of times exceeding the maximum allowable number of times of relaying, determined to a value different from one sort of communication to another, is no longer relayed.

20. The communication network apparatus according to claim 17 wherein each communication terminal apparatus of said set of communication terminal apparatus includes service rendering rejecting means for rejecting the rendering of part or all of communication services to the communication relayed by a number of times exceeding the maximum allowable number of times of relaying, determined to a value different from one sort of communication to another.

21. A method for determining a network address in a communication network apparatus comprising a set of communication relaying apparatus and a set of communication terminal apparatus, interconnected by a transmission route; each communication relaying apparatus of said set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of said information in said packet, and packet transmitting means for transmitting the packet, freed of the information of one or more bits, to said relaying destination, wherein
the information of one or more bits representing each relaying destination for each communication relaying apparatus existing on a route from a communication terminal apparatus of a source of transmission to a communication terminal apparatus of a destination of transmission is stated in the route sequence so as to be used as a network address.

22. A communication method in a communication network apparatus comprising a set of communication relaying apparatus and a set of communication terminal apparatus, interconnected by a transmission route; each communication relaying apparatus of said set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of said information in said packet, and packet transmitting means for transmitting the packet, freed of the information of one or more bits, to said relaying destination, said method comprising:
stating, in a packet a network address in the sequence of a route from a communication terminal apparatus of a source of transmission to a communication terminal apparatus of a destination of transmission, the information of one or more bits representing each relaying destination for each communication relaying apparatus existing on said route, and transmitting the resulting packet.

23. The communication method according to claim 22 further comprising:
storing a port number, determining the sort of the communication, in rear of said network address.

24. The communication method according to claim 22 further comprising:
storing the information specifying the priority of communication ahead of said network address.

25. The communication method according to claim 22 for a case in which a network address from a communication terminal apparatus or a communication relaying apparatus as a source of packet transmission to a communication terminal apparatus or a communication relaying apparatus as a destination of packet transmission is known and a return address for communication in the reverse direction is unknown, said method comprising:
generating a network address for communication in the reverse direction by reversing the bit sequence of the address from the source of transmission to the destination of transmission, stating the so generated network address in the packet and transmitting the resulting packet.

26. The communication method according to claim 22 further comprising said communication terminal apparatus rejecting part or all of communication services for communication relayed a number of times exceeding the maximum allowable number of times of relaying determined to a value different from one sort of communication to another.

27. A communication terminal apparatus in a communication network apparatus comprising a set of communication relaying apparatus and a set of communication terminal apparatus, interconnected by a transmission route; each communication relaying apparatus of said set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of said information in said packet, and packet transmitting means for transmitting the packet, freed of the information of one or more bits, to said relaying destination;
said communication terminal apparatus comprising:
network address' stating means for stating, in the sequence of a route from a communication terminal apparatus of a source of transmission to a communication terminal apparatus of a destination of transmission, the information of one or more bits representing each relaying destination for each communication relaying apparatus existing on said route, in a packet; and
packet transmitting means for transmitting the packet which has said network address entered by said network address stating means.

28. The communication terminal apparatus according to claim 27 further comprising:
port number storage means for storing a port number for determining the sort of the communication in rear of said network address in said packet.

29. The communication terminal apparatus according to claim 27 further comprising:
priority information storage means for storing the information for specifying the communication priority ahead of said network address in said packet.

30. The communication terminal apparatus according to claim 27 for a case in which a network address from a communication terminal apparatus or a communication relaying apparatus as a source of packet transmission to a communication terminal apparatus or a communication relaying apparatus as a destination of packet transmission is known and a return address for communication in the reverse direction is unknown, said apparatus comprising:
network address generating means for generating a network address for communication in the reverse direction by reversing the bit sequence of the address from the source of transmission to the destination of transmission;
said network address generating means stating the network address generated by said network address generating means in a packet.

31. The communication terminal apparatus according to claim 27 further comprising:
service rendering rejection means for rejecting the rendering of part or all of communication services to communication relayed a number of times exceeding the maximum allowable number of times of relaying determined to a value different from one sort of communication to another.

32. A network name server apparatus connected to a communication network apparatus comprising a set of communication relaying apparatus and a set of communication terminal apparatus, interconnected by a transmission route; each communication relaying apparatus of said set of communication relaying apparatus including relaying destination determining means for determining one or more relaying destination from among a plurality of relaying destinations depending on the information of one or more bits in a received packet, information deleting means for deleting the information of one or more bits, used in determining the relaying destination, from the original location of said information in said packet, and packet transmitting means for transmitting the packet, freed of the information of one or more bits, to said relaying destination; each communication terminal apparatus of said set of communication terminal apparatus including network address stating means for stating, in the sequence of a route from a communication terminal apparatus of a source of transmission to a communication terminal apparatus of a destination of transmission, the information of one or more bits representing each relaying destination for each communication relaying apparatus existing on said route, in a packet, and packet transmitting means for transmitting the packet which has said network address entered by said network address stating means; said network name server apparatus comprising:
network address generating means for accepting an inquiry of an address, using, as a key, a name of a communication counterpart terminal apparatus, with which the communication terminal apparatus is to communicate, for generating a network address stating, in the sequence of a route from a communication terminal apparatus of a transmission source to a communication terminal apparatus of a transmission destination, the information of one or more bits representing each relaying destination for each communication relaying apparatus existing on said route; wherein
the network address generated by said network address generating means is returned, responsive to said inquiry, as a network address relaying between said terminal apparatus.

33. The network name server apparatus according to claim 32 wherein, if there is a common gateway between a communication route from a communication terminal apparatus of a source of inquiry to a communication terminal apparatus of the destination of transmission and a communication route from the network name server apparatus to the communication terminal apparatus of the destination of transmission, said network address generating means removes a portion of the address from the network name server apparatus to the gateway from the address from the network name server apparatus to the terminal apparatus of the destination of transmission and substitutes the address from the communication terminal apparatus of the source of inquiry to the gateway for the removed address portion to generate a network address from the communication terminal apparatus of the source of inquiry to the communication terminal apparatus of the destination of transmission.
